(19) United States
(12) Patent Application Publication
(10) Pub. No.: US 2009/0103995 A1
(43) Pub. Date: Apr. 23, 2009

(54) Method and device for lubricating tool and workpiece at cutting

(76) Inventor: Ulrich Schlatter, Lyss (CH)

Correspondence Address: JORDAN AND HAMBURG LLP, 122 EAST 42ND STREET, SUITE 4000, NEW YORK, NY, 10168, US

(21) Appl. No.: 12/283,686

(22) Filed: Sep. 15, 2008

(30) Foreign Application Priority Data
Sep. 14, 2007 (EP) 07018133.4

(51) Int. Cl. B23Q 1/00

(52) U.S. Cl. 409/136

(57) ABSTRACT

The invention relates to a method and a device for lubricating tool and workpiece at cutting and forming, especially fine blanking of a workpiece with a thickness of 5 mm or more and with complex part geometry from a flat strip.

The invention has the task to further develop a method and a device for lubricating a tool and a workpiece at cutting and forming, especially at fine blanking of workpieces, so that fine blanking of thicker parts is reproducible controlled process secure with high quality and at the same time extended edge life of the tools by lubricating the active surfaces up to the forming zone without the provided lubricating film breaking off.

This task is solved in the manner that from the stocked up cutting oil one quantity is accumulated in a micro-surface structure of a functional surface of shearing punch and cutting die and evenly distributed on the functional surfaces as quasi-stationary cutting oil film by cooperation of moving past each other functional surfaces, when the tool is closed, and that one quantity of accumulated cutting oil via the respective effective gaps is provided to the active surfaces of shearing punch and workpiece in the forming zone.

The invention relates to a method for lubricating tool and workpiece at cutting and forming, especially fine blanking of a workpiece with a thickness of 5 mm or more and with complex part geometry from a flat strip, wherein the flat strip wetted on the surface with a lubricating oil film of sufficient thickness at closing is clamped between an upper part consisting of a shearing punch, a pressure pad for the shearing punch, a V-shaped projection positioned on the pressure pad and an ejector and a lower part consisting of cutting die, ejector and a inner form punch, and the lubricating oil by the pressure pad, the shearing punch, the ejector, the cutting die, the ejector and the inner form punch is pressed out and forced into chamfers at the pressure pad and the ejectors forming lubrication bore reliefs in which it is temporarily stocked up.

The invention further relates to a method for lubricating tool and workpiece at cutting and forming, especially fine blanking of a workpiece with a thickness of 5 mm or more and with complex part geometry from a flat strip, wherein the flat strip wetted on the surface with a lubricating oil film of sufficient thickness at closing is clamped between an upper part consisting of a shearing punch, a pressure pad for the shearing punch, a V-shaped projection positioned on the pressure pad and an ejector and a lower part consisting of cutting die, ejector and a inner form punch, wherein the effective gaps between shearing punch and pressure pad, cutting die and ejector as well as shearing punch and inner form punch are supplied with cutting oil.

The invention further relates to a method for lubricating tool and workpiece at cutting and forming, especially fine blanking of a workpiece with a thickness of 5 mm or more and with complex part geometry from a flat strip with a tool consisting of two parts with at least one shearing punch, one pressure pad for the shearing punch, one positioned on the pressure pad V-shaped projection, one ejector, one cutting die, one ejector and an inner form punch, wherein the flat strip wetted on both sides with a lubricating oil film of sufficient thickness is clamped between pressure pad and cutting die and the lubricating oil on the upper side of the workpiece is collected in chamfers positioned at the pressure pad and the ejector and on the bottom side in chamfers at the cutting die and the ejector forming lubrication bore reliefs, wherein effective gaps between shearing punch and pressure pad, cutting die and ejector and shearing punch and inner form punch are provided to supply the cutting oil.

The invention further relates to a method for lubricating tool and workpiece at cutting and forming, especially fine blanking of a workpiece with a thickness of 5 mm or more and with complex part geometry from a flat strip, with a tool consisting of two parts with at least one shearing punch, one pressure pad for the shearing punch, one positioned on the pressure pad V-shaped projection, one ejector, one cutting die, one ejector and an inner form punch, wherein the flat strip wetted on both sides with a lubricating oil film of sufficient thickness is clamped between pressure pad and cutting die and effective gaps between shearing punch and pressure pad, cutting die and ejector and shearing punch and inner form punch are provided to supply the cutting oil.

### STATE OF THE ART

It is known that fine blanking because of the high wear can not be realized without lubricating oil. Fine blanking without lubricating oil especially in case of thicker parts already after a few strokes leads to bonding between the shearing punch and the material of the workpieces. Beside this in case of thinner parts occurs a fast bluntness of the tool.

As known from “Umformen und Feinschneiden—Handbuch für Verfahren, Stahlwerkstoffe, Teilegestaltung” (R. A. Schmidt, Carl-Hanser-Verlag 2007, Munich, Vienna, p. 241-243) the wear stress of the shearing punch, the cutting die, the V-shaped projection and the inner form punch in the fine blanking tool reaches a serious degree and the tendency towards cold bondings between punch and workpiece heavily grows especially in case of a workpiece thickness of more than 10 mm.

To oppose wear and cold bonding this state of the art proposes to provide the workpiece or the strip on the upper and lower sides with an oil film of sufficient thickness. The lubricated strip is pushed into the open tool and clamped between the upper and the lower parts of the tool when it closes. The oil on the upper and lower sides of the strip on the one hand is pressed out by the pressure pad, the shearing punch and the ejector of the cutting tool and on the other hand by the cutting plate, the ejector and the inner form punch and forced into lubrication bore reliefs, on the upper side of the strip formed by chamfers at the pressure pad and the ejector and on the bottom side by a chamfer at the ejector.

Despite all theses measures it stayed a problem to provide a sufficient quantity of lubricating oil to the forming zone, so that fine blanking of parts thicker than 10 mm and with complex part geometry until now could not win through.

From DE 1 752 239 is further known to apply a die-plate of porous hard metal. Lubricating material deposits in the pores of the die-plate. This shall contribute to the lubricating film not breaking off during cutting. This known solution can not secure that the lubricant can reach the forming zone.

### Task

At this state of the art the invention has the task to further develop a method and a device for lubricating a tool and a workpiece at cutting and forming, especially at fine blanking of a workpiece, so that fine blanking of thicker parts is reproducible controlled process secure with high quality and at the same time extended edge life of the tools by lubricating the active surfaces up to the forming zone without the provided lubricating film breaking off.

This task is solved by a method of the kind mentioned above with the characterizing elements of the claims 1 and 5 and by a device with the characterizing elements of the claims 12 and 13.

Advantageous aspects of the method and the tool can be learned from the subclaims.

The solution according to this invention is characterized in that from the stocked up cutting oil a first partial quantity is accumulated in a micro-surface structure of a functional surface of shearing punch and cutting die and evenly distributed on the functional surfaces as quasi-stationary cutting oil film by cooperation of moving past each other functional surfaces, when the tool is closed, and that a second partial quantity of cutting oil via the respective effective gaps is provided to the active surfaces of shearing punch and workpiece in the forming zone.

The lubrication of the active surfaces of shearing punch or inner form punch and workpiece further can be enhanced by permanently providing an additional quantity of fine blanking oil under controllable pressure to the effective gaps via a conduit extending in the shearing punch, the ejector and the inner form punch of which a first partial quantity is accumulated in a micro-surface structure of a functional surface of shearing punch and cutting die and evenly distributed on the functional surfaces of shearing punch and pressure pad, ejector and cutting die and ejector and inner form punch as quasi-stationary cutting oil film by cooperation of moving past each other functional surfaces, when the tool is closed, and that a second partial quantity of cutting oil via the respective effective gap is provided to the active surfaces of shearing punch and workpiece in the forming zone.

Depending on workpiece thickness, geometry and material of the parts to be fine blanked are chosen the size or dimensions of the chamfers at the pressure pad and the ejectors or the pressure for providing the cutting oil, so that a sufficient quantity of cutting oil is provided in the lubrication bore reliefs or at the outlet openings. That means in other words, that the quantity of cutting oil with rising workpiece thickness has to respectively rise and for the chamfers or the oil pressure have to be chosen bigger values, respectively.

The quantity of oil provided from the lubrication bore reliefs to the forming zone is determined by the quantity of oil that can be accumulated in the micro-surface structure, which depends on the geometry, shape and depth of the micro-surface structure of the functional surfaces. In order to bring a sufficient quantity of lubricating oil to the forming zone the oil accumulation volume of the micro-surface structure is respectively adjusted to the workpiece thickness, material an geometry.

The micro-surface structure of the functional surfaces of shearing punch and inner form punch as well as of cutting die and ejector consists of indentations and/or pits and/or bore holes in μm-range produced by precise laser beam machining without finishing or grinding or milling. These indentations and/or pits and/or bore holes fill up with cutting oil that stays there because of the functional surfaces passing each other and being subjected to the high temperatures caused at the friction places, so that a lubricating film can develop.

The method according to this invention makes it possible to economically apply fine blanking also to workpieces or strips of steel or aluminum thicker than 5 mm and to reach a high process security and reproducible precision at the production of the parts.

The functional surfaces, i.e. the surface areas of shearing punch and inner form punch as well as the guide surfaces of cutting die and ejector have indentations and/or pits and/or bore holes of nearly identical geometry, shape and depth, so that it can be secured that the oil accumulated in the indentations and/or pits and/or bore holes is not removed during cutting. The quantity of fine blanking oil provided above that is transported to the forming zone. Resulting from this the forming zone is provided with a sufficient quantity of fine blanking oil with additives, so that the tendency towards cold bondings at the active surfaces between shearing punch and workpiece is significantly reduced and the wear of the fine blanking tools can be significantly reduced bringing along the advantage of a significantly longer edge life of the tools.

The indentations and/or longish pits and or bore holes cover the functional surfaces in a regular arrangement, which is formed of one above or beneath the other horizontally arranged and not connected to each other rows of indentations and/or pits and/or bore holes, wherein the indentations and/or pits and or bore holes of opposite rows are arranged in a staggered manner to each other, so that an extremely dense regular covering of the functional surfaces with the indentations and/or pits and/or bore holes is reached. This has the advantage that the lubricant forms an even quasi-stationary cutting oil film on the functional surfaces of shearing punch and inner form punch, cutting die and ejector, what leads to a further decrease of wear of the active elements of the tool.

Further advantages and details accrue from the following description with reference to the attached figures.

### EMBODIMENT

In the following the invention will be explained in more detail at the example of two embodiments.

It is shown in

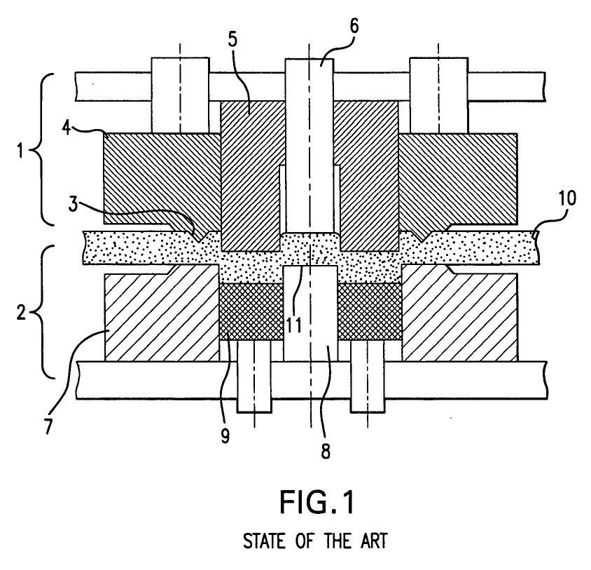

FIG. 1 a schematic view of the principle structure of a fine blanking tool according to the state of the art,

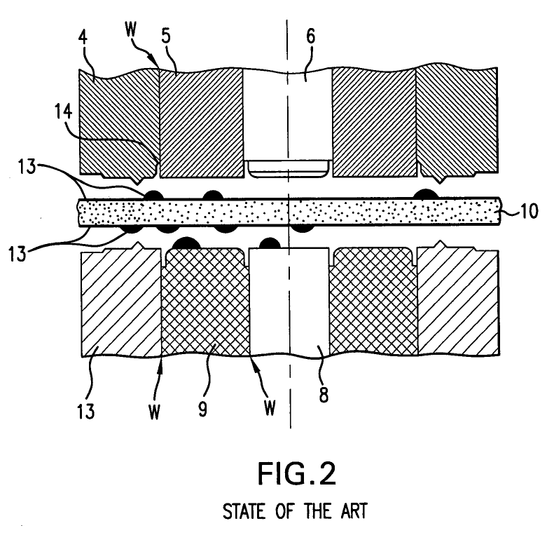

FIG. 2 a schematic view of the lubrication in a fine blanking tool according to the state of the art,

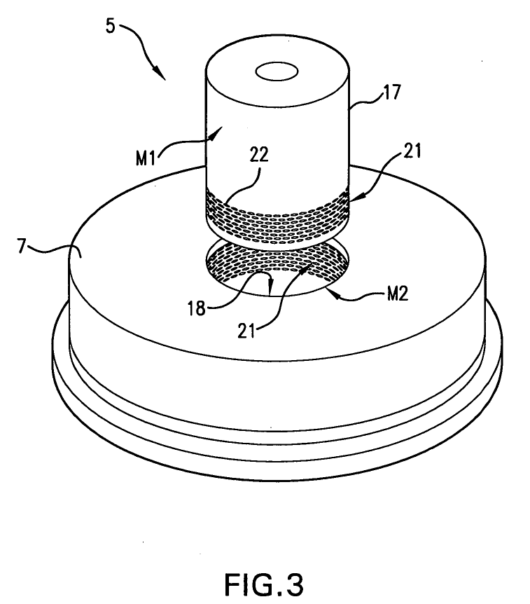

FIG. 3 a perspective view of the micro-surface structure on the functional surfaces of the device according to this invention,

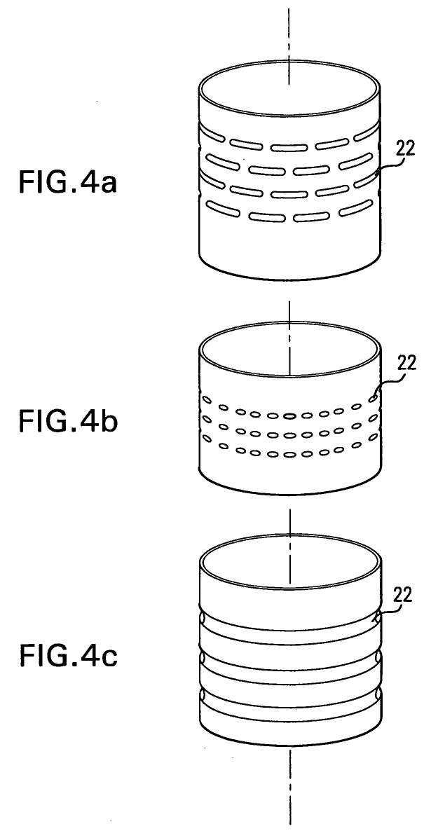

FIGS. 4a, 4b and 4c further variations of the micro-surface structure,

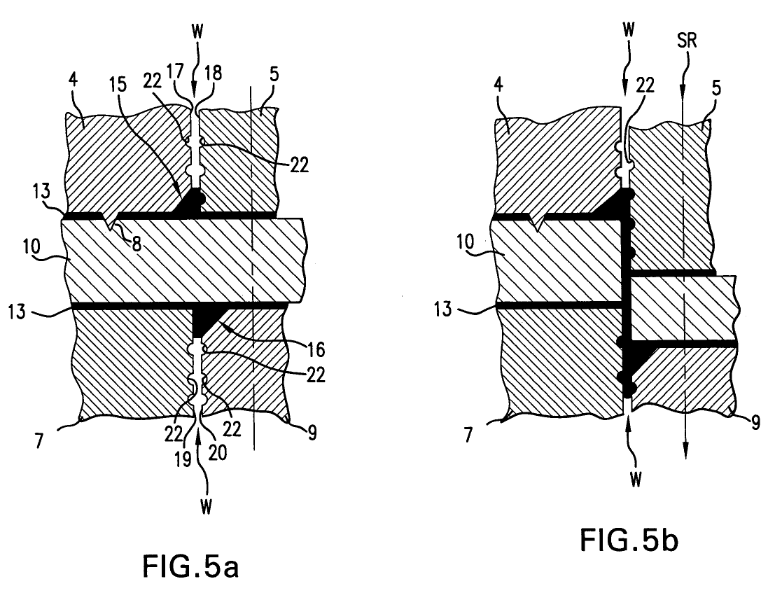

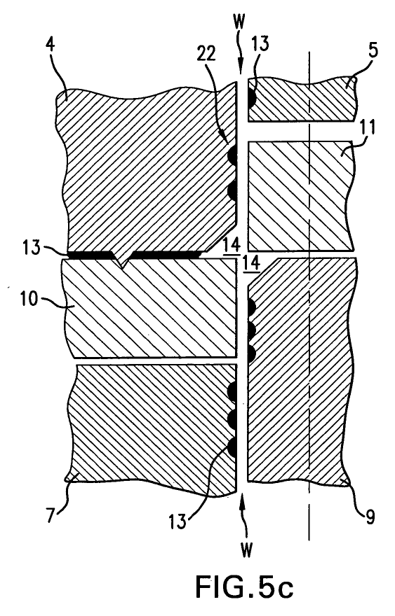

FIG. 5a to 5c a schematic view of the execution of the method according to this invention in the effective gap according to this invention,

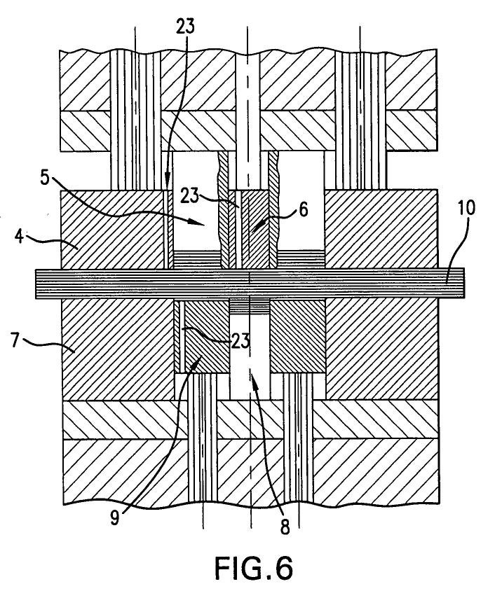

FIG. 6 a cross-section through a further device with additional feeding of cutting oil according to this invention,

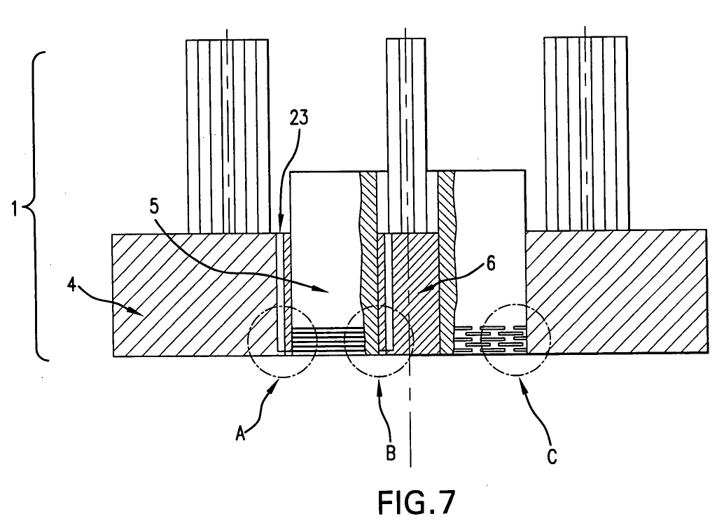

FIG. 7 an enlarged view of the upper part of the device according to this invention,

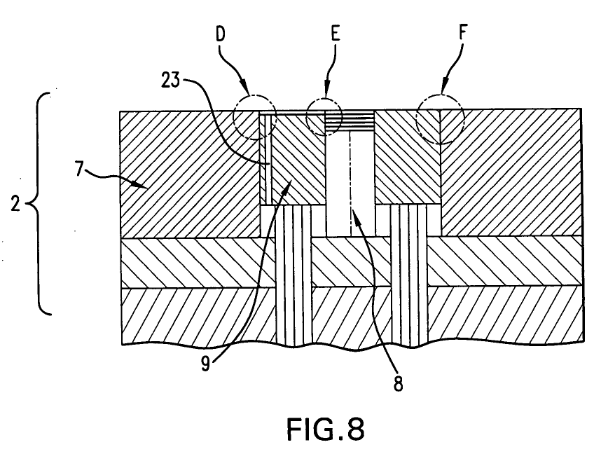

FIG. 8 an enlarged view of the lower side of the device according to this invention,

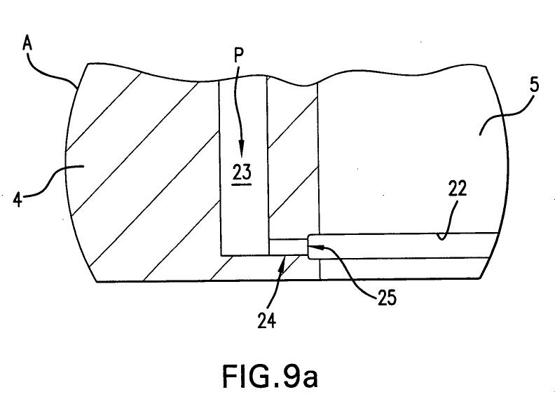

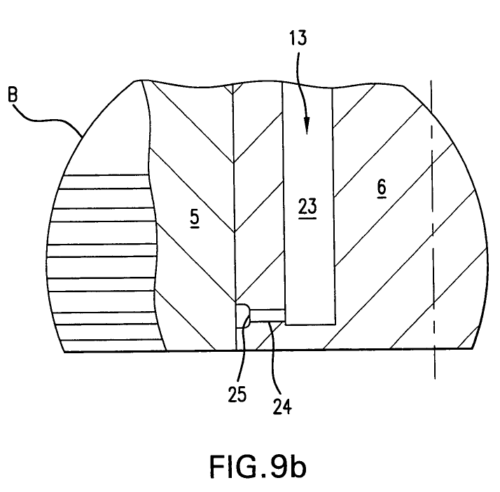

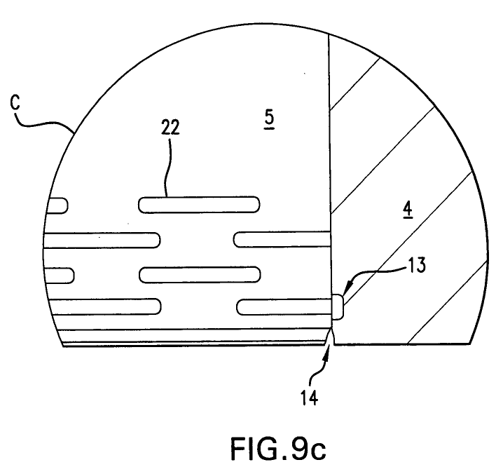

FIGS. 9a, 9b and 9c details A, B, and C of FIG. 7 and

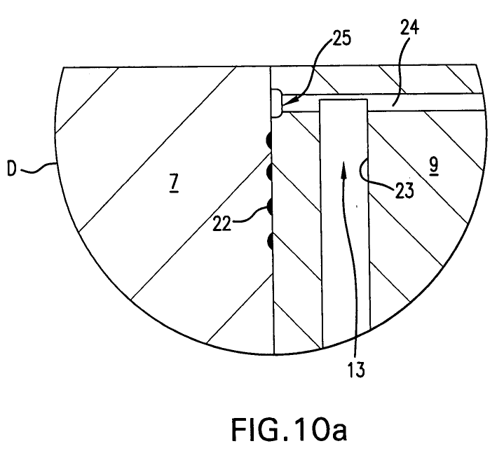

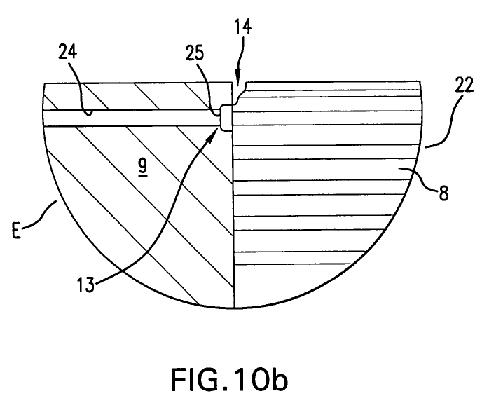

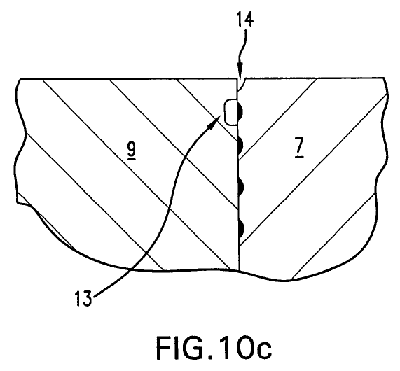

FIG. 10a, 10b and 10c details D, E and F of FIG. 8.

FIG. 1 shows the principle structure of a fine blanking tool according to the state of the art in the closed state. The fine blanking tool has an upper part 1 and a lower part 2. The upper part 1 of the fine blanking tool comprises a pressing pad 4 with a V-shaped projection 3, a shearing punch 5 guided in pressing pad 4 and an ejector 6. The lower part 2 consists of a cutting die 7, an inner form or hole punch 8 and an ejector 9. The strip 10 made of alloyed stainless steel with a thickness of 12 mm from which according to the method of this invention shall be fabricated a fine blanked part 11, for example a connecting flange from a steel strip, according to the shown state of the tool is clamped between pressing pad 4 and cutting die 7 and the V-shaped projection 3 has already penetrated the strip 10, whereby the material due to the applied force of the V-shaped projection is prevented from continue flowing during cutting. The cutting die 7 and the inner form fall 12 have cut about half the material thickness of the fine blanking part.

The wear stress of shearing punch 5, V-shaped projection 3, cutting die 7 and inner form punch 8 is correspondingly high, so that sufficient lubrication of the friction places with cutting oil is necessary to carry out the fine blanking.

FIG. 2 schematically shows the known from the state of the art measures to secure the lubrication of a fine blanking tool in the open state of the tool.

Basic precondition of the lubrication in the fine blanking tool is an even coating of the incoming strip with the cutting oil 13 when the tool is open. To secure an even coating or the existence of the oil coating of the strip it is useful to check the oil and coating thickness at the incoming strip. The very viscous cutting oil 13 comprises wetting agents and additives which at high pressures and temperatures, occurring for example at the friction places in the fine blanking tool, form passivated layers with the active surfaces, working against the inclination to cold bonding.

When the tool closes the strip 10 coated with cutting oil 13 on the upper and the lower sides is clamped between pressure pad 4 and cutting die 7. The pressure pad 4, the shearing punch 5 and the ejector 6 press on the upper side of strip 10 and the cutting die 7, the ejector 9 and the inner form punch 8 on the lower side of the strip, whereby the cutting oil 13 is pressed from the surfaces into the lubrication bore reliefs 14, which are formed by chamfers 15 at the pressure pad 4 and at the ejector 6 of the upper part 1 and by a chamfer 16 at the ejector 9 at the lower part 2 of the fine blanking tool. The cutting oil 13 pressed out from the surface of strip 10 collects in the lubrication bore reliefs 14 and can penetrate seen from the upper side of strip 10 along the effective gaps W formed between pressure pad 4 and shearing punch 5 as well as shearing punch 5 and ejector 6 into the workpiece and the functional surfaces 17 and 18, when the shearing punch 5 moves in the cutting direction, i.e. the convex surface of the shearing punch 5 and the guiding surface of the pressure pad 4 are accordingly lubricated. Lubrication of the tool from the lower side of the strip is realized by the oil, that accumulated in the lubrication bore relief 14 arranged at ejector 9. The cutting oil is carried in cutting direction, when the ejector 9 moves, and via effective gap W formed between cutting die 7 and ejector 9 reaches the functional surfaces 19 and 20, i.e. on the one hand the outer convex surface of the ejector 9 and the guiding surface of the cutting die 7 and on the other hand the inner convex surface of the ejector 9 and the convex surface of the inner form punch 8.

It is secured knowledge, that at fine blanking the inclination to cold bondings between shearing punch 5 and fine blanking part 11 increases with increasing thickness of the material. At a workpiece thickness of more than 10 mm fine blanking in general is not process secure any more and gets increasingly uneconomic because of the unreasonable finishing expenditure. The reason of these disadvantages are found in the circumstance, that because of the high pressure the cutting oil is pressed out of the effective gaps and thus despite all these known lubrication measures a break off of the cutting oil flow can not be prevented with increasing thickness of parts.

### Embodiment 1

The device according to this invention in embodiment 1 in general corresponds with the structure of the device which was described at hand of FIG. 1. FIG. 3 shows the micro-surface structure 21 according to this invention at the example of the functional surfaces 17 and 18 of shearing punch 5 and cutting die 7. The convex surface M1 of shearing punch 5 and the convex surface M2 of cutting die 7 are polished and for instance coated with titanium carbonitride. A multitude of indentations 22 fabricated by means of laser beam machining or other suitable machining operations like grinding or milling or the like covers the convex surfaces M1 and M2. The average depth of the indentations 22 is about 0.05 mm. The indentations 22 extend in horizontal rows with regular distances to each other, which are arranged perpendicular to the cutting direction SR. The functional surfaces 17 and 18 are regularly covered with these indentations.

These indentations 22 can have a different geometry and shape. So for example, longish grooves, pits, slots, ore entirely circular grooves or even bore holes can be placed in the functional surfaces. Within this only has to be secured, that rows of indentations 22 arranged above or beneath each other do not have connections to each other which extend in the cutting direction. Examples of various indentations 22 are given in FIG. 4.

The sequence of the method according to this invention is described at the example of FIG. 5a to 5c. In FIG. 5a the strip 10 is clamped between pressure pad 4 and cutting die 7. The cutting oil 13 pressed from the upper side of strip 10 fills the lubrication bore reliefs 14 at the pressure pad 4 and the ejector 9. The indentations 22 formed into the functional surfaces 17 and 18 of shearing punch 5 and pressure pad 4 are not yet filled with cutting oil 13 from the lubrication bore reliefs 14.

As soon as the shearing punch 5 moves on in the cutting direction SR the indentations 22 pass the lubrication bore relief 14 and a respective quantity of cutting oil is removed from the lubrication bore reliefs at the upper side of the workpiece due to the geometry and the shape of the surface structure of the convex surface of the shearing punch during its down movement in the cutting direction.

The indentations fill up with cutting oil 13 accumulated in lubrication bore relief 14, what is illustrated in FIG. 5b by a complete blackening of the concerned indentations 22. The removed and accumulated in the surface structure quantity of oil is carried on and is evenly distributed on the functional surfaces passing by each other, whereby a quasi-stationary cutting oil film is created on the functional surfaces 17 and 18.

Synchronous to the forward movement of the shearing punch 5 the ejector 9 moves in the cutting direction SR. Those indentations 22 in the functional surface 20 of cutting die 7 along which the lubrication bore relief 14 filled with cutting oil from the lower side of the strip passes the ejector 9 fill up with cutting oil. The accumulated in the surface structure quantity of cutting oil is also evenly distributed on the functional surfaces as quasi-stationary cutting oil film, when the functional surfaces 19 and 20 pass by.

The effective gaps W between pressure pad 4 and shearing punch 5 on the one hand and cutting die 7 and ejector 9 on the other hand is totally filled with cutting oil, so that cutting oil 13 from the lubrication bore relief can reach the active surfaces in the forming zone.

After fully cutting the strip 10 the shearing punch 5 and the ejector 9 move against the cutting direction SR. The functional surface 19 of the ejector passes the filled with oil indentations 22 in the functional surface 20 of the cutting die 7 and thus is respectively lubricated (see FIG. 5c). The indentations 22 in the respective functional surfaces 17 and 18 or 19 and 20 stay largely covered both in the and against the cutting direction by the respective convex surfaces of shearing punch 5 or pressing pad 4 or cutting die 7 or ejector 9, so that the oil accumulated in the indentations 22 of the micro-surface structure despite the movement of shearing punch 5 and ejector 9 quasi-stationary stays in the indentations 22.

The geometrically regular distribution of the indentations 22 on the functional surfaces 17 or 18 and 19 or 20 increases the effect of steadiness of the lubrication of the functional surfaces. The lubrication effect is further enhanced by the effect that the high temperature occurring in the friction places promotes the creation of a passivated layer due to the conversion of the additives like chlorine, phosphates or sulfonates, what in the last instance decreases the inclination towards cold bondings, especially in case of workpieces with a thickness of more than 10 mm.

By calculating the dimensions, i.e. the size of the chamfers 15 or 16 at the pressure pad 4 and at the ejector 9 the capacity of the lubrication bore reliefs 14 can be respectively changed. A greater thickness of the workpieces needs a greater quantity of cutting oil to be provided to the friction places, so that by choosing a bigger chamfer 15 or 16 also the accumulated quantity of cutting oil in the lubrication bore relief 14 can be increased.

The quantity of cutting oil that is transported into the forming zone by the shape, geometry and depth of the micro-surface structure can be determined, so that thicker workpieces can be fine blanked in a secure process.

To provide the necessary quantity of cutting oil for the lubrication according to this invention it turned out to be appropriate to control the thickness of the coating or the cutting oil quantity on the strip by means of an oil and coating thickness check before the strip gets into the fine blanking tool. This facilitates to adjust the thickness of the cutting oil film on the workpiece in dependence on the thickness, the material and the geometry of the workpiece.

### Embodiment 2

FIG. 6 to 8 show a further variation of the device according to this invention that in its principle structure resembles the structure of the tool described in FIG. 1. In addition to the lubricating bore reliefs 14 at the pressure pad 4 and the ejector 9 the pressure pad 4, the ejector 9 and the ejector 6 respectively have a conduit 23 for providing additional cutting oil 13 via the effective gaps between pressure pad 4 an shearing punch 5, shearing punch 5 and ejector 6 and cutting die 7 and ejector 9 into the respective micro-surface structure. The conduit 23 is connected to a not shown feeding pipe for the connection to a pressure pump for delivering pressure for the cutting oil 13 to be provided. The conduit 23 exceeding in the pressure pad 4, in the ejectors 9 and 6 in the cutting direction SR goes over to a section 24 exceeding perpendicular to the cutting direction with an opening 25 widening to the effective gap, through which can be provided cutting oil 13 under permanent pressure to the effective gaps.

In FIG. 9a to 9c and 10a to 10c are shown details of the delivery of cutting oil. It is clear that the opening 25 of the conduit 23 meets the indentations 22 near the cutting edge of the punch in the convex surface of the shearing punch 5, so that the cutting oil 13 being under pressure can totally fill the indentation 22. In case of movement of the shearing punch 5 in the cutting direction SR the above lying indentations 22 necessarily pass the opening 25 of conduit 23 and are also filled with cutting oil 13. The effective gap W between pressure pad 4 and shearing punch 5 is evenly filled with cutting oil 13 that is evenly distributed on the functional surface between pressure pad 4 and shearing punch 5, when the shearing punch 5 is moving.

Via opening 25 of conduit 23 in ejector 9 the cutting oil 13 under pressure gets into the indentations 22 of cutting die 7. The effective gap W between cutting die 7 and ejector 9 is filled with cutting oil that is evenly distributed onto the functional surfaces 19 and 20 when the ejector 9 is moving. Via effective gap W the cutting oil 13 reaches the active surfaces in the forming zone, i.e. the place where the shearing punch cuts the workpiece.

### LIST OF REFERENCE SIGNS

upper part of the fine blanking tool 1
lower part of the fine blanking tool 2
V-shaped projection 3
pressure pad 4
shearing punch 5
ejector 6
cutting die (die-plate) 7
inner form ore hole punch 8
ejector 9
strip 10
fine blanking part 11
inner form fall 12
cutting oil 13
lubrication bore reliefs 14
chamfers 15, 16
functional surfaces of 4 and 5 17, 18
functional surfaces of 6 and 7 19, 20
micro-surface structure 21
indentations 22
conduit 23
section of 23 24
opening of 23 25
convex surface of 5 M1
convex surface of 7 M2
cutting direction SR
effective gap W

1. Method for lubricating tool and workpiece at cutting and forming, especially fine blanking of a workpiece with a thickness of 5 mm or more and with complex part geometry from a flat strip, wherein the flat strip wetted on the surface with a cutting oil film of sufficient thickness at closing is clamped between an upper part consisting of a shearing punch, a pressure pad for the shearing punch, a V-shaped projection positioned on the pressure pad and an ejector and a lower part consisting of cutting die, ejector and a inner form punch, and the cutting oil by the pressure pad, the shearing punch, the ejector, the cutting die, the ejector and the inner form punch is pressed out and forced into chamfers at the pressure pad and the ejectors forming lubrication bore reliefs in which it is temporarily stocked up, characterized in that from the stocked up cutting oil one quantity is accumulated in a micro-surface structure of a functional surface of shearing punch and cutting die and evenly distributed on the functional surfaces as quasi-stationary cutting oil film by cooperation of moving past each other functional surfaces, when the tool is closed, and that one quantity of accumulated cutting oil via the respective effective gaps is provided to the active surfaces of shearing punch and workpiece in the forming zone.

2. Method according to claim 1, characterized in that the quantity of accumulated cutting oil in the lubrication bore reliefs by dimensioning the chamfers at pressure die and ejectors in dependence on the workpiece thickness and geometry is adjusted to the lubrication situation.

3. Method according to claim 1, characterized in that the layer thickness of the cutting oil film on the workpiece by an oil and layer thickness control is adjusted in dependence on the thickness of the workpiece, material of the workpiece and work piece geometry.

4. Method according to claim 1, characterized in that the quantity of cutting oil provided to the forming zone is determined by shape, geometry and depth of the micro-surface structure.

5. Method for lubricating tool and workpiece at cutting and forming, especially fine blanking of a workpiece with a thickness of 5 mm or more and with complex part geometry from a flat strip, wherein the flat strip wetted on the surface with a cutting oil film of sufficient thickness at closing is clamped between an upper part consisting of a shearing punch, a pressure pad for the shearing punch, a V-shaped projection positioned on the pressure pad and an ejector and a lower part consisting of cutting die, ejector and a inner form punch, wherein the effective gaps between shearing punch and pressure pad, cutting die and ejector as well as shearing punch and inner form punch are supplied with cutting oil, characterized in that the effective gaps are permanently provided with an additional quantity of fine blanking oil under controllable pressure via a conduit extending in the shearing punch, the ejector and the inner form punch of which one quantity is accumulated in a micro-surface structure of a functional surface of shearing punch and cutting die and evenly distributed on the functional surfaces of shearing punch and pressure pad, ejector and cutting die and ejector and inner form punch as quasi-stationary cutting oil film by cooperation of moving past each other functional surfaces, when the tool is closed, and one quantity of cutting oil via the respective effective gap is provided to the active surfaces of shearing punch and workpiece in the forming zone.

6. Method according to claim 5, characterized in that the additionally provided quantity of cutting oil is controlled in dependence on the thickness of the workpiece by a pressure produced by a pump.

7. Method according to claim 1, characterized in that the micro-surface structure of the functional surfaces of shearing and inner form punches as well as of the cutting die is fabricated by laser beam, grinding or milling machining.

8. Method according to claim 7, characterized in that the convex surfaces of the shearing and the inner form punches as well as the guiding surface of the cutting die are used as functional surfaces.

9. Method according to claim 1, characterized by following successively executed steps:
a) shearing off and removing a quantity of cutting oil from the lubrication bore reliefs on the upper side of the workpiece due to geometry and shape of the surface structure of the convex surface of the shearing punch during its down movement in cutting direction,
b) carrying on the sheared off quantity of oil from the micro-surface structure of the convex surface of the shearing punch according to step a) and distributing the carried on quantity of oil as quasi-stationary oil film up to the cutting or forming zone,
c) shearing off and removing a quantity of cutting oil from the lubrication bore reliefs on the lower side of the workpiece due to the surface structure of the convex surface of the ejector and
d) carrying on the sheared off quantity of cutting oil from the surface structure of the convex surface of the ejector and distributing the carried on quantity of oil on the surface structure of the guiding surface of the cutting die when the convex surface of the ejector passes the guiding surface of the cutting die against the cutting direction.

10. Method according to claim 1, characterized in that as strip is used a strip made of steel or aluminum.

11. Method according to claim 1, characterized in that as cutting oil is used a mixed with phosphates, sulfonates or if necessary chlorine high viscous lubrication oil.

12. Device for lubricating tool and workpiece at cutting and forming, especially fine blanking of a workpiece with a thickness of 5 mm and more from a strip according to claim 1 with a tool consisting of two parts with at least one shearing punch (5), a pressure pad (4) for the shearing punch (5), a positioned on the pressure pad V-shaped projection (3), an ejector (6), a cutting die (7), an ejector (9) and an inner form punch (8), wherein the flat strip wetted on both sides with a cutting oil film of sufficient thickness is clamped between pressure pad (4) and cutting die (7) and the cutting oil on the upper and lower sides of the workpieces collected in chamfers (15, 16) positioned at the pressure pad (4) and the ejector (6) and at the cutting die (7) and the ejector (9) forming lubrication bore reliefs (14), wherein effective gaps (W) between shearing punch and pressure pad, cutting die and ejector and shearing punch and inner form punch are provided to supply the cutting oil, characterized in that at least the shearing punch (5) and the cutting die (7) on their functional surfaces (17, 18 or 19, 20) have a perpendicularly to the cutting direction (SR) arranged regularly distributed over the functional surfaces micro-surface structure (21) for receiving and evenly distributing cutting oil in a quasi-stationary layer thickness via the effective gaps (W) up to the forming zone.

13. Device for lubricating tool and workpiece at cutting and forming, especially fine blanking of a workpiece with a thickness of 5 mm and more from a strip according to claim 2 with a tool consisting of two parts with at least one shearing punch (5), a pressure pad (4) for the shearing punch (5), a positioned on the pressure pad V-shaped projection (3), an ejector (6), a cutting die (7), an ejector (9) and an inner form punch (8), wherein the flat strip wetted on both sides with a cutting oil film of sufficient thickness is clamped between pressure pad (4) and cutting die (7) and effective gaps (W) between shearing punch and pressure pad, cutting die and ejector and shearing punch and inner form punch are provided to supply the cutting oil, characterized in that in the pressure pad (4), in the ejector (9) and in the ejector (6) is arranged a conduit (23) with outlet opening (25) for the additional controlled supply of cutting oil into the effective gaps (W) and that at least the shearing punch (5) and the cutting die (7) on their functional surfaces (17, 18) have a perpendicularly to the cutting direction (SR) arranged regularly distributed over the functional surfaces micro-surface structure (21) for receiving and evenly distributing cutting oil in a quasi-stationary layer thickness via the effective gaps (W) up to the forming zone.

14. Device according to claim 12, characterized in that the ejector (9) on its functional surface (19, 20) has a micro-surface structure (21).

15. Device according to claim 12, characterized in that the convex surfaces of shearing punch (5) and ejector (9) are provided as functional surfaces (17, 18).

16. Device according to claim 12, characterized in that the guiding surfaces of pressure pad (4) and cutting die (7) are provided as functional surfaces (19, 20).

17. Device according to claim 12, characterized in that the functional surfaces of shearing punch, ejector, pressure pad and cutting die are polished and/or coated.

18. Device according to claim 12, characterized in that the micro-surface structure (21) is formed of not connected to each other groove-shaped indentations (22) and/or longish pits and/or bore holes, which at least cover a part of the functional surfaces.

19. Device according to claim 18, characterized in that the surfaces of the indentations and/or pits and/or bore holes are polished and/or coated.

20. Device according to claim 18, characterized in that the indentations and/or pits and/or bore holes are arranged in a regular pattern which is formed of above or beneath each other arranged horizontal rows of indentations and/or pits and/or bore holes, wherein the indentations and/or pits and/or bore holes of opposite rows are arranged in a staggered manner to each other.

21. Device according to claim 18, characterized in that the indentations and/or longish pits of different rows overlap each other.

22. Device according to claim 18, characterized in that the indentations and/or pits and/or bore holes have a depth of 0.03 to 0.05 mm.

23. Device according to claim 12, characterized in that the size of the chamfers at the pressure pad and the ejectors is dimensioned according to the thickness of the workpiece.

24. Device according to claim 13, characterized in that the conduit (23) is connected to a cutting oil reservoir hold under pressure.
